(19) United States
(12) Patent Application Publication
(10) Pub. No.: US 2009/0282492 A1
(43) Pub. Date: Nov. 12, 2009

(54) INFORMATION PROCESSING APPARATUS, INFORMATION PROCESSING METHOD, AND STORAGE MEDIUM

(75) Inventor: Takeshi Takahashi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/463,418

(22) Filed: May 10, 2009

(30) Foreign Application Priority Data
May 12, 2008 (JP) 2008-124572

(51) Int. Cl. G06F 17/00; G06F 21/00

(52) U.S. Cl. 726/27; 715/255

(57) ABSTRACT

A main control unit acquires a security attribute of object data and a security attribute of a storage destination directory and compares the acquired security attributes. The main control unit determines whether target object data is storable based on the comparison result. If the main control unit determines that the target object data is not storable, the main control unit presents alternative options.

### BACKGROUND OF THE INVENTION

1. Field of the Invention

The present invention relates to a technique for managing object data based on original images.

2. Description of the Related Art

To improve efficiency of office work, reuse of office documents is desired. In the related art, an image processing apparatus for dividing image data for each meaningful area and attaching attribute information to each of the divided areas has been proposed.

“Area data” indicates not only divided image data but also text data extracted from the divided areas using character recognition technology, such as optical character recognition (OCR), and digital watermark information embedded using a digital watermarking technology. Hereinafter, the “area data” that is extracted from an original image and is attached with metadata (such as attribute information) is referred to as object data.

With the increasing concern about security of documents shared in offices, a technique for prohibiting a specific operation performed on documents including confidential information has been proposed (see, Japanese Patent Laid-Open No. 2004-185568).

To provide a display device having improved usability regarding classified documents, the technique disclosed in Japanese Patent Laid-Open No. 2004-185568 determines whether information to be displayed includes confidential information using character retrieval of confidential words and pattern matching. If it is determined that the information to be displayed includes confidential information, the display device is prevented from displaying the information.

A case where a document is created by reusing object data for which a security level is set will be discussed.

A case where a document is created by combining such object data may include a case where a document creator creates a document by combining a plurality of pieces of object data.

If the document creator carelessly stores a document including object data having a security level set as confidential, the confidential information may undesirably be disclosed. To avoid disclosure of the confidential information, storage of such a document may not be permitted. However, users may be unable to discriminate between a case where storage of the document is not permitted due to the security level of the object data and a case where a storage procedure is wrong.

In such a case, some sort of access restriction may be provided for object data. For example, a high security level (confidential) or a low security level may be set for each object data. In this case, a security level set for a document that users created by combining a plurality of pieces of object data has to be carefully considered.

Since users may reuse object data registered by other users to combine a plurality of pieces of object data, it is difficult for the users to accurately determine the security level of each object data.

### SUMMARY OF THE INVENTION

According to an aspect of the present invention, an information processing apparatus includes a display control unit configured to display a document created using object data to which a security level is set as attribute information, and a presenting unit configured to present, at the time of execution of processing on the document displayed by the display control unit, second object data different from first object data when a result of comparison of the security level corresponding to content of the processing to be executed on the document and the security level of the first object data included in the document displayed by the display control unit indicates that the security level of the first object data included in the document displayed by the display control unit is higher than the security level corresponding to the content of the processing to be executed on the document.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a configuration of a document management system according to an exemplary embodiment of the present invention.

FIG. 2 is a block diagram illustrating a hardware configuration of each personal computer (PC) constituting a document management system according to an exemplary embodiment of the present invention.

FIG. 3 is a diagram illustrating a software configuration of an example of a document management system according to an exemplary embodiment of the present invention.

FIG. 4 is a diagram illustrating a data structure of object data handled in a document management system according to an exemplary embodiment of the present invention.

FIG. 5 is a diagram showing an object data utilization example of a document management system according to an exemplary embodiment of the present invention.

FIG. 6 is a diagram showing an example of attributes attached to object data shown in FIG. 5 as metadata.

FIG. 7 is a diagram showing table information regarding a directory stored in a document storage unit shown in FIG. 3.

FIG. 8 is a flowchart showing an example of a first data processing procedure performed by a document management system according to an exemplary embodiment of the present invention.

FIG. 9 is a diagram showing an example of a user interface displayable by a document management system according to an exemplary embodiment of the present invention.

FIG. 10 is a diagram showing an example of a user interface displayable by a document management system according to an exemplary embodiment of the present invention.

FIG. 11 is a flowchart showing an example of a second data processing procedure performed by a document management system according to an exemplary embodiment of the present invention.

FIG. 12 is a diagram showing an example of a user interface displayable by a document management system according to an exemplary embodiment of the present invention.

FIG. 13 is a flowchart showing an example of a third data processing procedure performed by a document management system according to an exemplary embodiment of the present invention.

FIG. 14 is a diagram illustrating a data structure of object data handled in a document management system according to an exemplary embodiment of the present invention.

FIG. 15 is a diagram showing an example of object data edition processing performed by a document management system according to an exemplary embodiment of the present invention.

FIG. 16 is a diagram showing a security attribute of object data 1401 shown in FIG. 15.

FIG. 17 is a diagram showing a state where a security-attribute attached restricted area of object data 1401 shown in FIG. 15 is hidden by displaying object data 1600 over the restricted area.

FIG. 18 is a flowchart showing an example of a fourth data processing procedure performed by a document management system according to an exemplary embodiment of the present invention.

FIG. 19 is a diagram illustrating a memory map of a storage medium that stores various data processing programs that can be read by a document management system according to an exemplary embodiment of the present invention.

### DESCRIPTION OF THE EMBODIMENTS

Exemplary embodiments of the present invention will be described with reference to the accompanying drawings.

### (Description of System Configuration)

### First Exemplary Embodiment

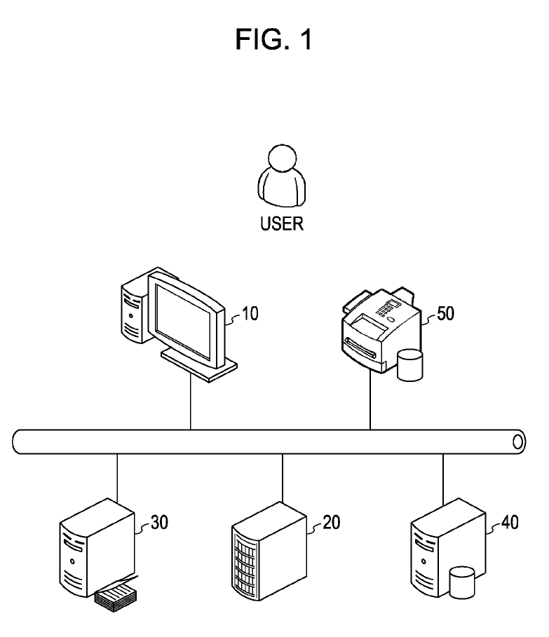

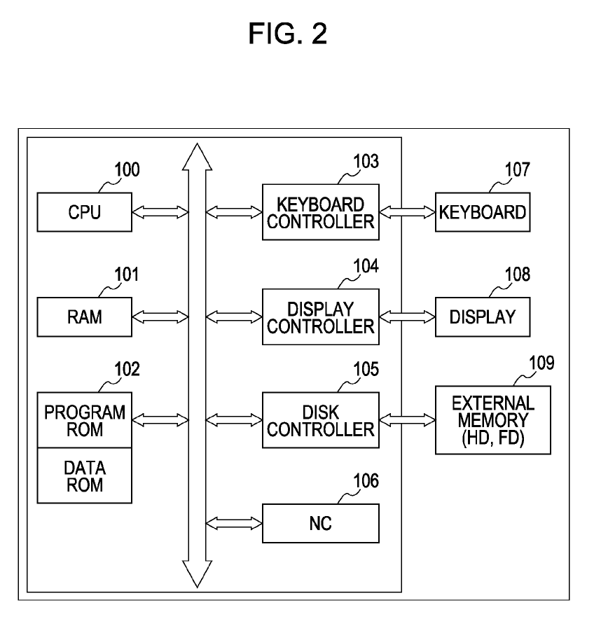

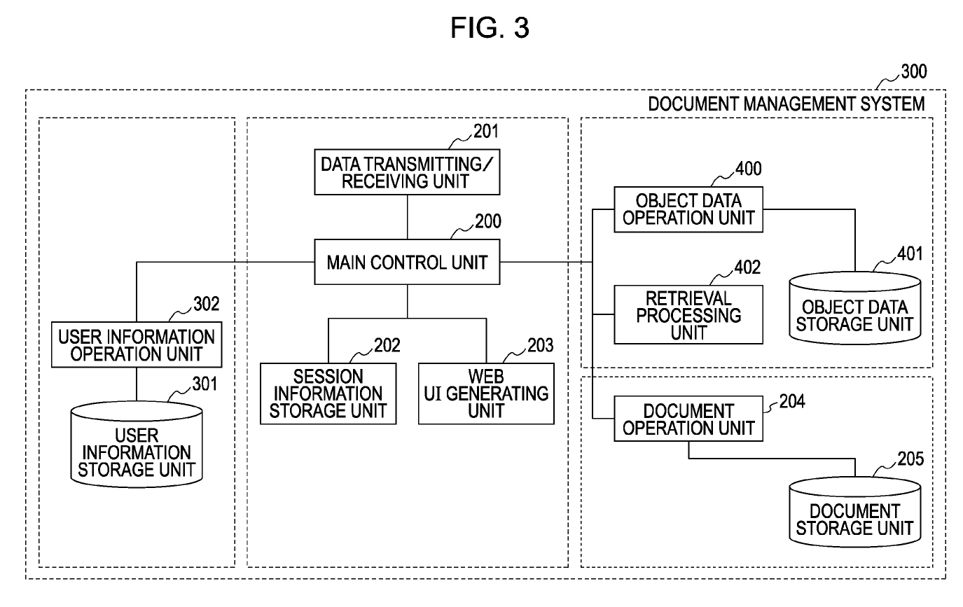

FIG. 1 is a diagram illustrating a configuration of a document management system according to a first exemplary embodiment. In the document management system, a client PC 10, a web application server PC 20, a user management server PC 30, and an object data management server PC 40 are connected to a network in a communication-executable manner. The client PC 10, the web application server PC 20, the user management server PC 30, and the object data management server PC 40 have hardware resources shown in FIG. 2. Furthermore, the client PC 10, the web application server PC 20, the user management server PC 30, and the object data management server PC 40 have software resources shown in FIG. 3.

Referring to FIG. 1, a user accesses the document management system through a browser of the client PC 10. The web application server PC 20 provides a web application of the document management system. The user management server PC 30 manages information on users accessing the document management system. The object data management server PC 40 has a function for storing and managing object data.

The user management server PC 30 authenticates users logging into the system. Accordingly, the user management server PC 30 stores user authentication information and user attribute information in a storage device. For example, information on an organization that a user belongs to, a project that the user participates in, and a role of the user is stored in the user management server PC 30 as the user attribute information according to this exemplary embodiment.

A multifunction device 50 has a function for scanning paper documents and can extract object data from image data at the time of creation of the image data. The extracted object data is stored in a hard disk drive (HDD) included in the multifunction device 50. The object data may be transmitted to the object data management server PC 40 and stored in a storage device included in the object data management server PC 40. A user can select the object data storage destination, i.e., the object data management server PC 40 or the multifunction device 50. Original images from which the object data is extracted may be scanned images and images supplied at the time of printing.

Object data stored in the storage device, e.g., an HDD, included in the multifunction device 50 can be referred to from the web application server PC 20 that provides a document management function. Accordingly, a user accessing the web application server PC 20 from the client PC 10 does not have to be aware of a storage destination like the object data stored in the object data management server PC 40.

Although the web application server PC 20, the user management server PC 30, and the object data management server PC 40 are separately provided in the example system shown in FIG. 1, the web application server PC 20, the user management server PC 30, and the object data management server PC 40 may be constituted by a single PC.

Although a user operates the client PC 10, the user may operate one or all three server PCs.

Although a user accesses the document management system according to this exemplary embodiment through a browser of a PC, the user may operate the client PC 10 having a dedicated client application, not shown. In this case, the dedicated client application may communicate with the object data management server PC 40 instead of the web application server PC 20.

### (Hardware Configuration)

FIG. 2 is a block diagram illustrating a hardware configuration of each PC constituting the document management system according to this exemplary embodiment. A hardware configuration of a general information processing apparatus can be applied to each PC according to this exemplary embodiment.

Referring to FIG. 2, a central processing unit (CPU) 100 executes programs, such as an operating system (OS) and applications stored in a program read-only memory (ROM) of a ROM 102 or loaded into a random access memory (RAM) 101 from an external memory 109. Here, the OS is an abbreviation of an operating system operating in a computer. Hereinafter, the operating system is abbreviated as OS. Processing shown as each flowchart to be described below can be realized by execution of programs.

The RAM 101 functions as a main memory and a work area of the CPU 100. A keyboard controller 103 controls key input from a keyboard 107 and a pointing device, not shown.

A display controller 104 controls various kinds of information displayed on a display 108. A disk controller 105 controls data access to the external memory 109, such as a hard disk (HD) and a flexible disk (FD), storing various kinds of data. A network controller (NC) 106 is connected to a network and controls communication with other devices connected via the network.

### (Software Configuration)

FIG. 3 is a diagram illustrating a software configuration of the document management system according to this exemplary embodiment.

FIG. 3 shows a software configuration of the web application server PC 20, the user management server PC 30, and the object data management server PC 40. In FIG. 3, each component enclosed by a rectangle corresponds to a software component. A configuration of the components depends on a system configuration and a platform.

A document management system 300 includes all of software components provided in the user management server PC 30, the web application server PC 20, and the object data management server PC 40 shown in FIG. 1.

A main control unit 200 controls the document management system 300 according to the exemplary embodiment. The main control unit 200 issues instructions to each component to be described later to manage the component.

A data transmitting/receiving unit 201 receives commands issued by a user through a browser of the client PC 10 and returns results for the instructions of the main control unit 200 to the client PC 10.

A session information storage unit 202 generates session information indicating that a specific user is continuously accessing the document management system 300 through the browser of the client PC 10. The session information storage unit 202 stores various kinds of repeatedly used information in association with the session information until the user stops accessing (logs out from) the document management system 300 or the session expires due to automatic timeout.

A web user interface (UI) generating unit 203 generates web UIs (HTML) corresponding to circumstances in accordance with instructions of the main control unit 200. The web UIs generated by the web UI generating unit 203 are not limited to HTML. Script languages, such as Java® script, may be embedded in the web UIs.

A document operation unit 204 performs operations, such as registration, storage, update, and extraction of a document, on a document storage unit 205 in accordance with instructions issued from the main control unit 200. The document storage unit 205 stores created documents, folders storing the documents, attributes of the folders, and security levels of the folders. The document operation unit 204 controls the document storage unit 205.

A user information operation unit 302 performs operations, such as acquisition and setting of information on users accessible to the document management system 300 and user attribute information stored in a user information storage unit 301 in accordance with instructions issued from the main control unit 200. Here, the document management system 300 alone does not have to perform the user management. The user information operation unit 302 may operate in cooperation with technologies according to the related art, such as the active directory and the LDAP, to perform user management. In this case, the user information storage unit 301 may store only the user attribute information.

An object data operation unit 400 performs operations, such as registration, storage, update, and extraction of object data, on an object data storage unit 401 in accordance with instructions issued from the main control unit 200. The object data includes area data (partial image data, text data, and digital watermark information) extracted from image data and metadata associated with the area data. The metadata includes, for example, attribute information to be described later.

The object data storage unit 401 also stores index information of the metadata included in the object data. The index information is used in retrieval of object data.

The object data operation unit 400 controls the object data storage unit 401.

A retrieval processing unit 402 retrieves information stored in the object data storage unit 401. Here, retrieval processing includes attribute retrieval processing for retrieving attribute information associated with object data, full text retrieval processing of text data, and similar image retrieval processing of image data. The retrieval processing unit 402 performs these kinds of retrieval processing in combination. The retrieval processing unit 402 also manages a retrieval process, such as timeout of retrieval processing, setting of the upper limit value of the number of retrieved results, and abortion of retrieval processing.

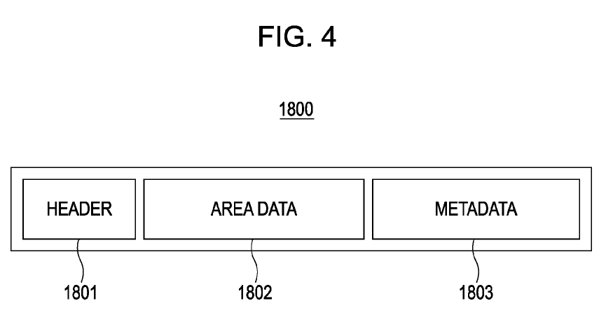

FIG. 4 is a diagram illustrating a data structure of object data handled in the document management system according to this exemplary embodiment.

As shown in FIG. 4, a data structure 1800 of object data includes a header 1801, area data 1802 mainly extracted from image data, and metadata 1803, such as a security attribute and a general attribute attached to the area data 1802.

The header 1801 includes a start offset value and a data length of an area data storage section and a metadata storage section to identify the area data storage section and the metadata storage section.

### (Utilization Example)

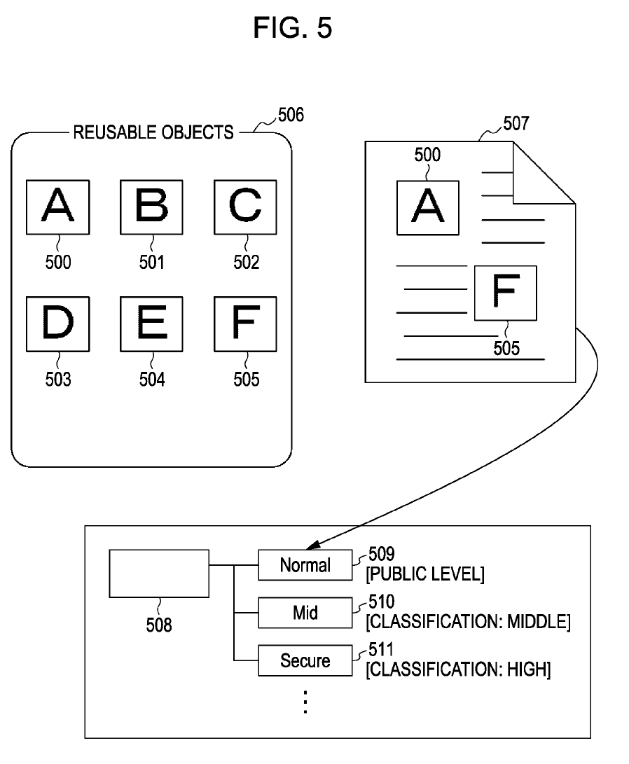

FIG. 5 is a diagram showing an object data utilization example in the document management system according to this exemplary embodiment.

Referring to FIG. 5, pieces of object data 500-505 stored in the object data storage unit 401 are displayed at a display area 506, which displays reusable object data. Accordingly, a user can reuse given object data by pasting the object data in a document at the time of creation of the document.

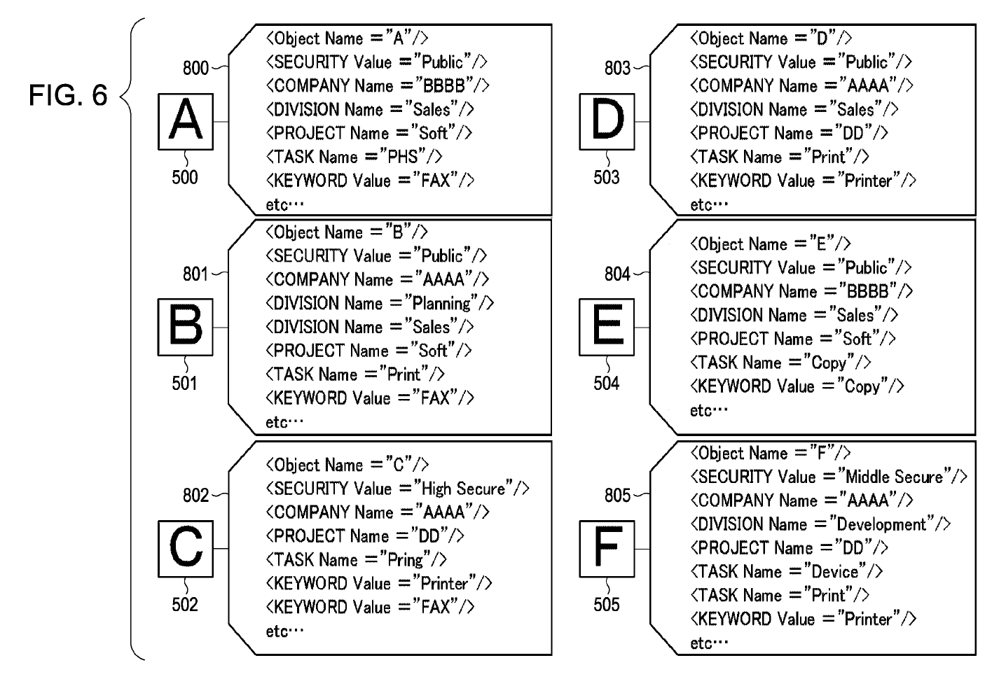

FIG. 6 is a diagram showing an example of attributes 800-805 that the pieces of object data 500-505 shown in FIG. 5 have as metadata, respectively.

At least while the metadata is managed in the system, the metadata is not lost even after the object data is pasted in the document but is stored with the object data that is associated as a part of the document.

At the time of division and generation of area data from original image data, various kinds of attribute information are set based on attribute information attached to a storage destination (such as a folder) of the area data and user information of a user having instructed generation of the object data. The various kinds of attribute information are also set using a predetermined method in accordance with attribute information of the original image data and related data of the area data of the original image data. The user or the system may set and change the attribute information through the object data operation unit 400 after generation and storage of the object data.

In particular, the security attribute is set in accordance with a predetermined method, such as inheriting the security attribute of the original image data or the storage destination, when the area data is generated from the original image data. The user or the system may set and change the security attribute through the object data operation unit 400 after generation and storage of the object data. In the example shown in FIG. 6, the security attribute is represented as “SECURITY Value.”

A directory 508 shown in FIG. 5 functions as a parent directory that includes a plurality of directories. Storage destination directories 509, 510, and 511 function as child directories of the parent directory 508. The storage destination directories 509, 510, and 511 indicate directories that can be specified as storage destinations of documents.

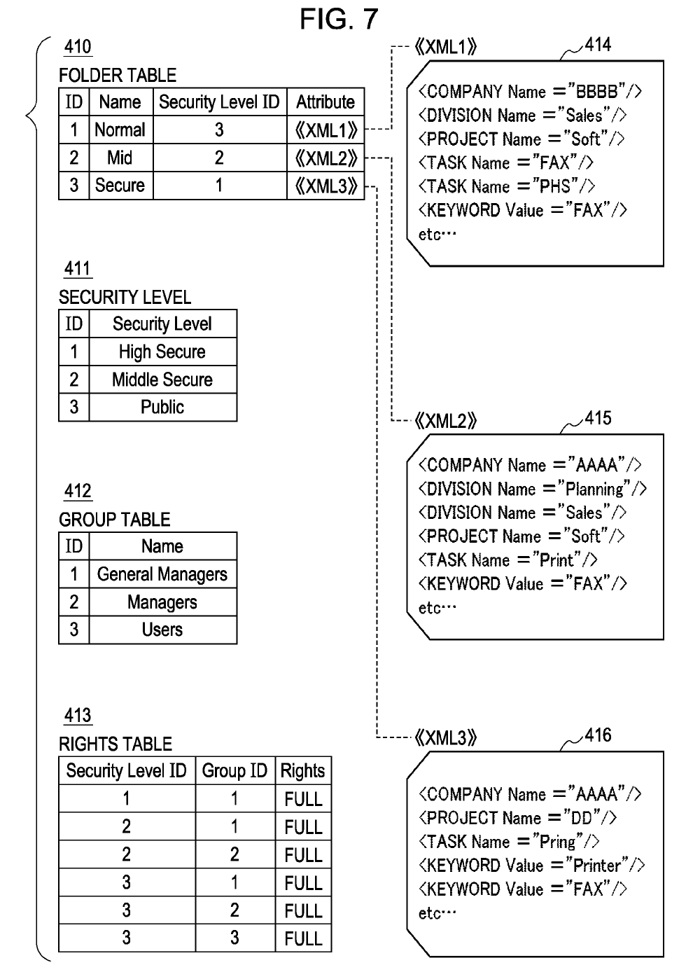

FIG. 7 is a diagram showing table information regarding the storage destination directories 509, 510, and 511 stored in the document storage unit 205 shown in FIG. 3. In this example, a relationship between a folder, a security level, a user group, and an access right is shown.

Referring to FIG. 7, a folder table 410 manages an ID number and a name of each of the storage destination directories 509, 510, and 511 shown in FIG. 5, and an ID number of a security level set for the directory. The folder table 410 also manages an attribute attached to the directory.

Here, attribute values 414-416 are stored in, for example, an XML format. However, a method for defining each attribute element as a table column or a method for separately defining and referring to an attribute table may be employed.

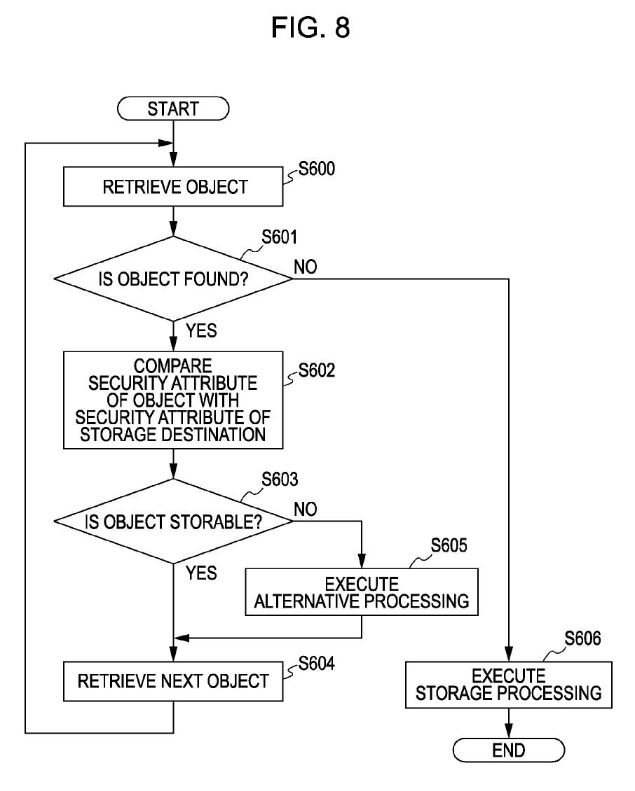

A security level table 411 manages an ID number and a name of the security level. Although a case of employing three security levels (high, middle, and public) is shown here, the security level table 411 may include other security levels. In this exemplary embodiment of the present invention, the security levels are defined as high, middle, and public from the higher security level. The security levels are used in comparison processing to be described with reference to FIG. 8.

A group table 412 manages an ID number, namely, one of “1”-“3,” of a user group that a user utilizing the document management system 300 belongs to and a name of the user group (such as general managers, managers, and users). The group table 412 may be managed by the user information storage unit 301 instead of the document storage unit 205.

A right table 413 defines and manages an access right corresponding to the security level. The right table 413 shows an access right that the security level specified by the ID provides to the user group. For example, regarding the security level ID 2, namely, “middle,” the right table 413 shows that a full access right, namely, all kinds of operations, is permitted for the group IDs of “1” and “2,” namely, the “general managers” and “managers.”

The access right is not granted to groups not listed in the right table 413.

For example, since the group ID “3,” namely, the “users,” is not listed in the right table 413 regarding the security level ID “2,” namely, “middle,” the “users” are not permitted to access directories and documents to which the security level “middle” is set.

According to the tables shown in FIG. 7, since the security level “public (open level)” is set for the storage destination directory 509 shown in FIG. 5, all groups can access the directory 509. Similarly, since the security level “middle (classification: middle)” is set for the directory 510, only the groups “general managers” and “managers” can access the directory 510. Additionally, since the security level “high (classification: high)” is set for the directory 511, only the group “general managers” can access the directory 511.

A document 507 is created by reusing object data displayed at the display area 506, which displays object data reusable in a document. The pieces of object data 500 and 505 displayed at the display area 506 are pasted in the document 507. The document 507 is not stored yet.

FIG. 8 is a flowchart showing an example of a first data processing procedure performed by the document management system according to this exemplary embodiment. This example shows processing performed when a user accesses the document management system shown in FIG. 1 and stores an unsaved document in a specific storage destination directory. Hereinafter, a description will be given for a case of storing the document 507 in the storage destination directory 509. The main control unit 200 operates in cooperation with each software component of the document management system 300, thereby realizing processing at steps S600-S606. More specifically, the CPU 100 shown in FIG. 2 executes the software components, thereby realizing the processing.

At S600, a user accesses the object data management server PC 40 using the client PC 10 to retrieve target object data. Here, it is assumed the object data 500 is found.

At S601, the main control unit 200 determines whether the object data is found. Here, the main control unit 200 determines that the object data 500 is found as described above. The process then proceeds to S602.

At S602, the main control unit 200 acquires a security attribute of the object data 500 and a security attribute of the storage destination directory 509. The main control unit 200 then compares the acquired security attributes. Both the object data 500 and the storage destination directory 509 have the security attribute “public.” In this case, the main control unit 200 determines that storage of the object data 500 in the storage destination directory 509 is permitted based on the security level.

At S603, the main control unit 200 determines whether the target object data is storable. Since the object data 500 has the security attribute indicating that the object data 500 can be stored in the storage destination directory 509, the process proceeds to S604.

At S604, the main control unit 200 retrieves next object data included in the document. Here, it is assumed that the object data 505 is found. The process then returns to S601 again. Since the object data 505 is found, the main control unit 200 compares the security attributes of the object data 505 and the storage destination directory 509 at S602 again.

As shown in FIG. 6, the object data 505 has the security attribute “middle,” which is higher than the security attribute “public” of the storage destination directory 509.

Accordingly, the main control unit 200 determines that storage of the object data 505 in the storage destination directory 509 is undesirable based on the comparison result. Thus, the main control unit 200 determines that “storage is not permitted” at S603. The process then proceeds to S605. The main control unit 200 determines that “storage is not permitted” here to prevent object data having the security attribute higher than “public” from being stored in a directory that can be accessed by anyone.

At S605, the main control unit 200 performs processing for presenting alternative options, which will be described in detail later. After the processing for presenting alternative options in this manner, S604 is executed again. However, since no other object data is included in the document 507, it is determined that object data is not found at S601. The process then proceeds to S606.

A plurality of alternative options will be described later. A user may select one of the options.

At S606, the main control unit 200 executes processing for storing the document 507 in the specified directory 509. The process then terminates.

In the description regarding this processing and the alternative options, a case of storing content in a specified storage destination is described using example processing of “storage” of a document (processing on a document). However, processing on the document other than “storage,” e.g., “printing” and “(email) transmission” of a created document may be employed instead. That is, processing content “storage” may be set as first processing content, whereas an operation other than “storage,” e.g., “printing” of a created document, may be set as second processing content. In this manner, the second processing content, which is different from the first processing content, can be presented after comparison of security levels of the processing content and the display controlled object data.

More specifically, when printing is performed as processing on the document, the processing according to the exemplary embodiment of the present invention is used by setting a security level corresponding to a print setting and comparing the set security level with that of object data. When email transmission is performed as processing on the document, similar processing is performed by setting a security level corresponding to address information.

### (Alternative Options)

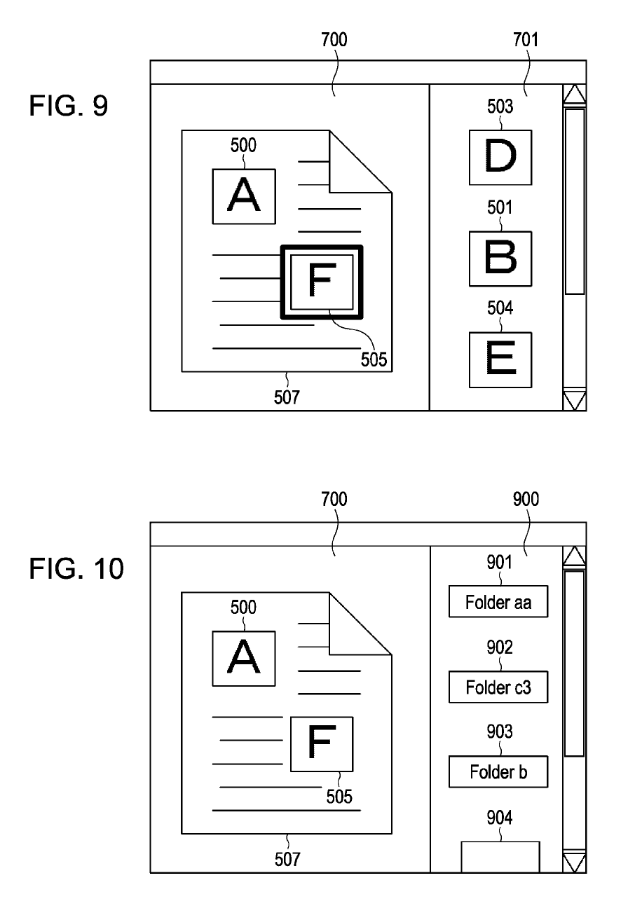

FIGS. 9 and 10 are diagrams showing examples of a user interface (UI) that can be displayed by the document management system according to the exemplary embodiment. The examples show UIs for presenting alternative options for a document including selected object data (object data determined not to be storable at S603, namely, the object data 505). The UIs are displayed in alternative option presenting processing performed at S605.

Referring to FIG. 9, an area 700 displays a document currently being edited. A mark is attached to target object data so that users can know the specified target object data. Although the object data is enclosed by a thick frame in this example, any other marks may be employed. The target object data indicates object data that is determined not to be storable at S603. In this example UI, the object data 505 corresponds to the target object data. Pieces of object data displayed at the area 700, e.g., the pieces of object data 500 and 505, are processed as first object data, whereas pieces of object data displayed at an area 701, e.g., the pieces of object data 501, 503, and 504, are processed as second object data.

The area 701 displays alternative object data candidates of the target object data. A list of the alternative object data candidates sorted according to similarity to the attribute of the target object data is displayed. For example, the pieces of object data 501, 503, and 504, which corresponds to the second object data, are displayed as the alternative object data candidates. The UI shown in FIG. 9 is presented to the client PC 10 under the control of the main control unit 200 and is displayed through a browser of the client PC 10.

Referring to FIG. 10, an area 900 displays a list of alternative storage destination candidates that can store the document including the target object data instead of the specified storage destination. More specifically, a list of alternative storage destination candidates sorted according to similarity to the attribute of the target object data is displayed as second processing content that is different from first processing content for displaying the alternative objects shown in FIG. 9. The UI shown in FIG. 10 is presented to the client PC 10 under the control of the main control unit 200 and is displayed through a browser of the client PC 10. The area 900 functions as an area for presenting alternative storage destination candidates.

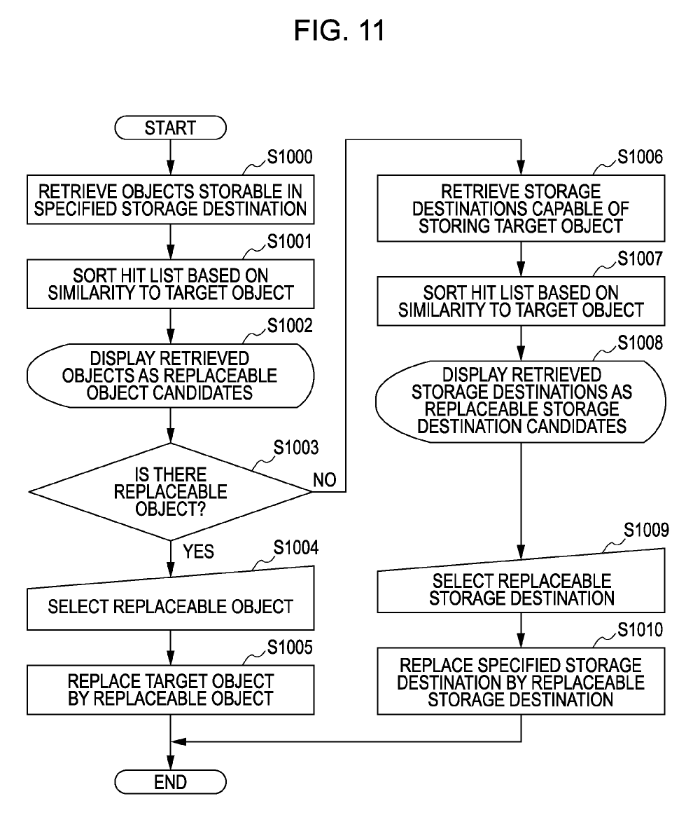

FIG. 11 is a flowchart showing an example of a second data processing procedure performed by the document management system according to this exemplary embodiment. This example shows processing for presenting alternative object data candidates and alternative storage destination folder candidates performed as the alternative option presenting processing at S605 shown in FIG. 8. The description will be given for an example case of storing the document 507 in the storage destination directory 509. The main control unit 200 operates in cooperation with each software component of the document management system 300, thereby realizing processing at steps S1000-S1010. More specifically, the CPU 100 shown in FIG. 2 executes the software components, thereby realizing the processing.

At S1000, the retrieval processing unit 402 retrieves object data storable in the specified storage destination from the object data storage unit 401. Since the storage destination directory 509 set as the specified storage destination has the security level “public,” the retrieval processing unit 402 retrieves object data having the security attribute equal to or lower than the security level “public.” In this case, since the security level “public” is the lowest level, the retrieval processing unit 402 retrieves only object data having the security level “public.” As shown in FIG. 6, since four pieces of object data 500, 501, 503, and 504, among the pieces of object data 500-504 shown in FIG. 5, satisfy this condition, these four pieces of object data are found.

At S1001, the retrieval processing unit 402 sorts the four pieces of object data found at S1000 according to similarity to the object data 505.

For example, when the attribute 805 of the object data 505 shown in FIG. 6 is compared with the attribute 803 of the object data 503, four element values match in addition to the security attribute. Accordingly, the similarity level 4 is set for the object data 503. Here, the four element values indicate “COMPANY Name,” “PROJECT Name,” “TASK Name,” and “KEYWORD Value.”

Since a result of comparison of the attribute 805 of the object data 505 and the attribute 801 of the object data 501 indicates that two element values, i.e., “COMPANY Name” and “TASK Name,” match in addition to the security attribute, the similarity level 2 is set for the object data 501. Accordingly, the object data 503 is more similar to the object data 505 than the object data 501. Since there are various methods for detecting similarity of attributes, the similarity may be detected using other methods.

The calculation of the similarity may be dynamically performed at S1001 or may be previously performed at the time of attachment or modification of attributes and stored in the object data storage unit 401.

At S1002, the UI shown in FIG. 9 is displayed on a display device through a browser of the client PC 10. The pieces of object data retrieved and sorted at S1000 and S1001, respectively, are displayed at the area 701 as alternative object data candidates. The UI shown in FIG. 9 is presented to the client PC 10 under control of the main control unit 200 and is displayed through the browser of the client PC 10.

At S1003, a user compares the alternative object data candidates (the object data 503, 501, and 504) displayed on the display device with the target object data (the object data 505) marked at the area 700 to determine whether the object data is replaceable. If the user determines that that object data is replaceable, the process proceeds to S1004. If the user determines that the object data is not replaceable, the process proceeds to S1006. Here, the main control unit 200 determines that the replaceable object data is found when the user selects object data or the user presses a button, not shown, after the selection.

At S1004, the user operates a pointing device or the like to select the replaceable object data from the alternative object data candidates displayed at the area 701 shown in FIG. 9.

At S1005, the object data operation unit 400 replaces the target object data used in the document 507 with the object data selected at S1004. The process then terminates.

At S1006, storage destinations that can store the target object data are retrieved. For example, since the object data 505 has the security level “middle,” storage destinations, such as directories, having the security levels equal to or higher than this level (in this case, “middle” and “high”) are retrieved.

At S1007, the storage destinations found at S1006 are sorted according to similarity to the object data 505. A similarity detection method employed at this time is based on the object data similarity detection method described at S1001. Similarity is detected using one of various similarity detection methods.

At S1008, the UI shown in FIG. 9 is switched into the UI shown in FIG. 10. More specifically, the storage destinations retrieved and sorted at S1006 and S1007, respectively, are displayed at the area 900 as alternative storage destination candidates.

At S1009, the user selects an appropriate storage destination from the displayed alternative storage destination candidates. At S1010, the currently specified storage destination is replaced with the storage destination candidate selected at S1009. The process then terminates.

According to this exemplary embodiment, it is possible to retrieve and present alternative options based on an attribute of object data. Accordingly, even if execution of a document operation, such as storage, printing, copying, and movement of a document utilizing object data, is not permitted because the object data does not satisfy a condition, user friendliness is improved. The first exemplary embodiment may provide a mechanism for flexibly performing processing suitable for a security level of object data at the time of creation of a document using the object data.

### Second Exemplary Embodiment

In the first exemplary embodiment, the description has been given for processing for presenting alternative object data candidates or alternative storage destination candidates when execution of a document operation is not permitted because object data does not satisfy a condition.

According to another alternative method, execution of the document operation may be permitted by newly added object data that can cancel or change a security attribute of target object data.

The second exemplary embodiment employs a basic configuration and user document edition processing similar to those of the first exemplary embodiment except for alternative options shown in FIGS. 9, 10, and 11. Alternative options characteristic to this exemplary embodiment will be described below.

### (Alternative Options 2)

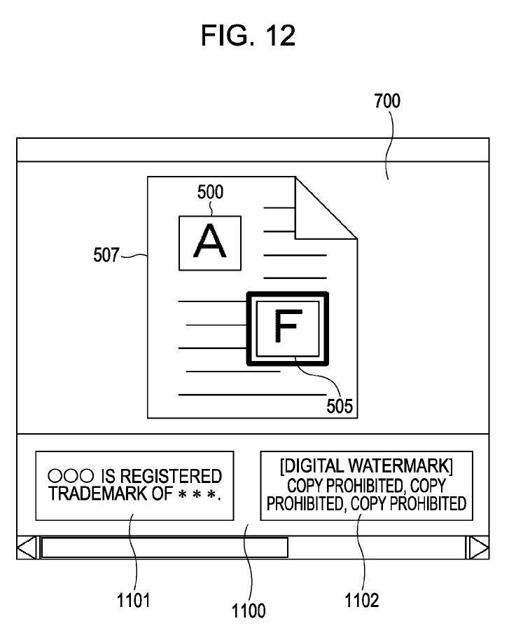

FIG. 12 is a diagram showing an example of a user interface displayed by a document management system according to this exemplary embodiment. This example shows a UI for displaying alternative object data as an alternative option. This UI is displayed through a browser of a PC operated by a user at S605 shown in FIG. 8.

Referring to FIG. 12, an area 1100 displays a list of neutralization object data candidates that can cancel or change a security attribute of target object data. This example corresponds to a state where neutralization object data candidates are displayed from the left according to similarity to the attribute of the target object data. The UI shown in FIG. 12 is presented to the client PC 10 under control of the main control unit 200 and is displayed through a browser of the client PC 10. The area 1100 functions as an area for presenting additional object data candidates.

Pieces of neutralization object data 1101 and 1102 correspond to third object data, for example. The neutralization object data 1101 is an example used in a case where the area data is an image. The neutralization object data 1102 is an example used in a case where the area data is a digital watermark. As described above, the area data of the neutralization object data is not necessarily an image but may be text or a digital watermark.

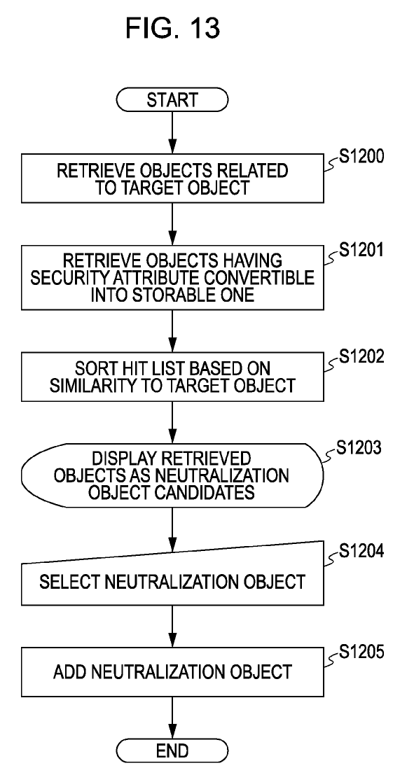

FIG. 13 is a flowchart showing an example of a third data processing procedure performed by the document management system according to this exemplary embodiment. This example shows processing for presenting alternative object data candidates as the alternative options of S605 shown in FIG. 8. The main control unit 200 operates in cooperation with each software component of the document management system 300, thereby realizing processing at steps S1200-S1205. More specifically, the CPU 100 shown in FIG. 2 executes the software components, thereby realizing the processing.

At S1200, the retrieval processing unit 402 retrieves related object data of target object data. Two kinds of attribute information, i.e., a name of the target object data and an influence on the target object data, are set for the related object data.

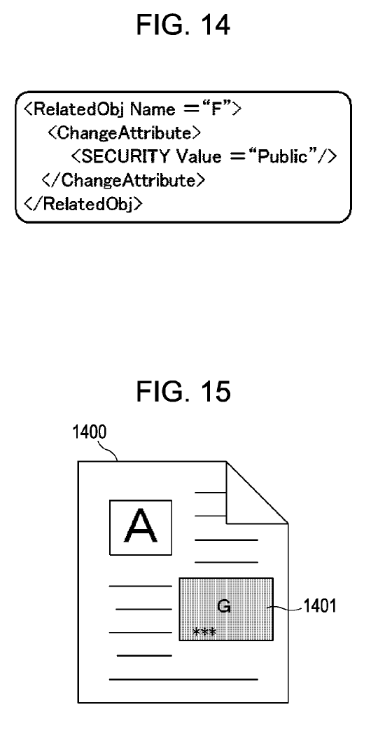

Referring to FIG. 12, the pieces of neutralization object data 1101 and 1102 have attributes shown in FIG. 14. “Related Obj Name=‘F’” indicates that the pieces of neutralization object data 1101 and 1102 are object data related to an object data name ‘F’.

In addition, the pieces of neutralization object data 1101 and 1102 have an influence “change attribute” on the target object data. That is, the pieces of neutralization object data 1101 and 1102 “change the attribute of the target object data.” The content of the change is “SECURITY Value=Public.” That is, the security attribute of the target object data is changed to “public.”

At S1201, the retrieval processing unit 402 retrieves, from the pieces of related object data found at S1200, object data that can change the security attribute (to public) of the target object data (i.e., the object data 505) by adding the object data in the related document so that the target object data can be stored in the storage destination directory 509.

At S1202, the retrieval processing unit 402 sorts the pieces of object data found at S1200 and S1201 according to similarity to the target object data. A logic used to determine the similarity to the target object data is similar to the logic for determining the similarity of the target object data and the alternative object data used in the first exemplary embodiment.

At S1203, the UI shown in FIG. 12 is displayed through a browser of a PC operated by the user. The pieces of object data retrieved and sorted at S1200, S1201, and S1202 are displayed at the area 1100 as neutralization object data candidates. The UI shown in FIG. 12 is presented to the client PC 10 under control of the main control unit 200 and is displayed through a browser of the client PC 10.

At S1204, the user operates a pointing device or the like to manually select neutralization object data from the neutralization object data candidates displayed at the area 1100. At S1205, the object data operation unit 400 adds the selected neutralization object data to the document. The process then terminates.

According to this exemplary embodiment, it is possible to retrieve and present additional object data that can change an attribute of target object data so that a condition is satisfied. Accordingly, since security of object data not satisfying a condition can be maintained and a document processing request can be continued at the time of execution of a document operation, such as storage, printing, copying, and movement, user friendliness is improved.

### Third Exemplary Embodiment

In the above-described exemplary embodiments, the description has been given for a case where storage of a document including object data not satisfying a security condition of a storage destination is not permitted at the time of various operations, such as storage, printing, copying, and movement of the document.

However, when a security attribute is limitedly attached to a specific area of object data that is hidden by other object data, execution of the document processing may be permitted.

Processing for determining whether object data is storable (S602 and S603 shown in FIG. 8), which is characteristic to this exemplary embodiment, will be described below. The third exemplary embodiment employs basic hardware and software configurations and document edition processing similar to those of the above-described exemplary embodiments.

FIG. 15 is a diagram showing an example of object data edition processing performed by a document management system according to this exemplary embodiment.

Referring to FIG. 15, a document 1400 is created by reusing object data. Object data 1401 is pasted in the document 1400.

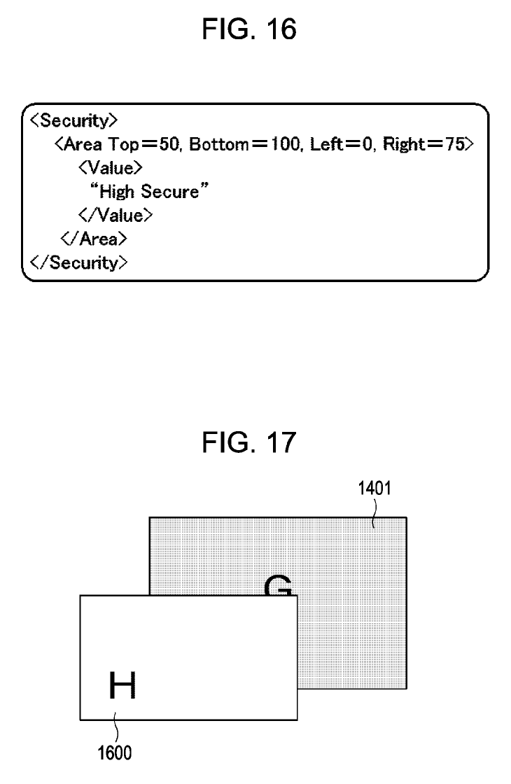

FIG. 16 is a diagram showing a security attribute of the object data 1401 shown in FIG. 15. An element “Area” of an element “security” of this attribute specifies an area protected by the security attribute. Here, “Top,” “Bottom,” “Left,” and “Right” define coordinates of the area data using percentages of height and width. More specifically, regarding the vertical direction, “Top=50” and “Bottom=100” indicate a lower half of the area data. Regarding the horizontal direction, “Left=0” and “Right=75” indicate 75% of the width of the area data from the left. Accordingly, the security attribute “high” is attached to the lower half of and 75% of width of the area data from the left.

FIG. 17 is a diagram showing a state where the security-attribute attached restricted area of object data 1401 shown in FIG. 15 is hidden by displaying object data 1600 over the restricted area. The object data 1600 corresponds to third object data, for example. The main control unit 200 controls processing of, for example, a document including the object data 1401 corresponding to the first object and the presented object 1600. A description will be given for an example in which the object data 1401 and the object data 1600 overlap.

In this case, since the area protected by the security attribute “high” is not displayed, the attribute “high” is not effective.

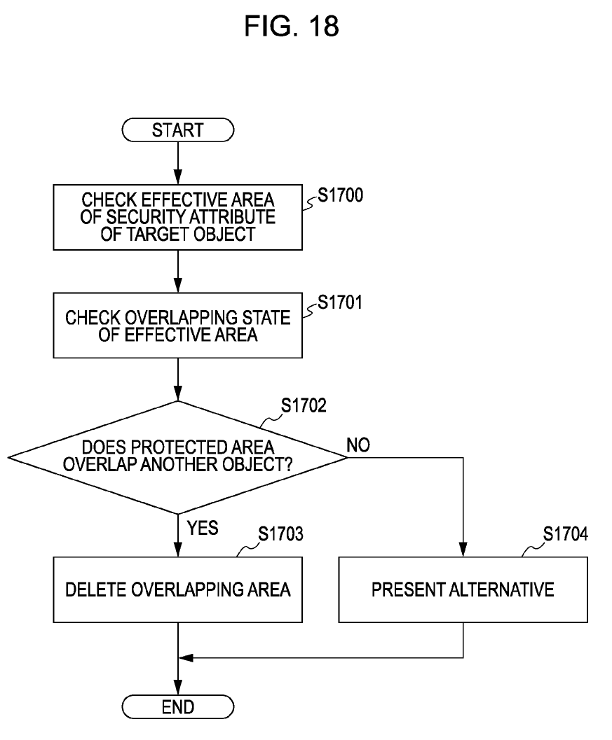

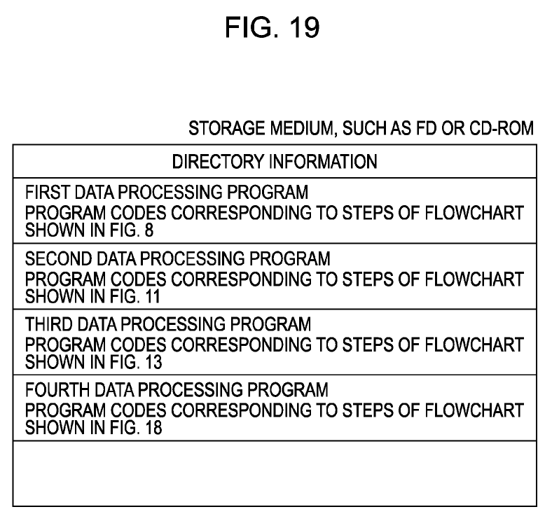

FIG. 18 is a flowchart showing an example of a fourth data processing procedure performed by the document management system according to this exemplary embodiment. This example shows document processing performed when the security attribute is limitedly attached to a specific area of the object data hidden by other object data. The main control unit 200 operates in cooperation with each software component of the document management system 300, thereby realizing processing at steps S1700-S1704. More specifically, the CPU 100 shown in FIG. 2 executes the software components, thereby realizing the processing.

At S1700, the object data operation unit 400 checks a security-attribute effective area of target object data. At S1701, the object data operation unit 400 checks whether other object data overlaps the area protected by the security attribute. The object data included in a document has position information so as to be arranged in the document. The object data operation unit 400 determines the overlapping state based on the layout information.

At S1702, the object data operation unit 400 determines whether the area protected by the security attribute is hidden by (is overlapping) other object data based on the overlapping state determined at S1701. If the object data operation unit 400 determines that the protected area is hidden, the process proceeds to S1703. Otherwise, the process proceeds to S1704.

At S1703, the object data operation unit 400 deletes the overlapping part so that the area protected by the security attribute does not remain in the document as data when the document is stored in a storage destination having a lower security level. The process then terminates. Instead of the above-described processing, the object data operation unit 400 may combine pieces of overlapping object data to create a single piece of object data, so that the security-attribute effective area does not remain in the document at S1703.

At S1704, the object data operation unit 400 performs processing for presenting other alternative options (see the above-described first exemplary embodiment) since the area protected by the security attribute is not hidden. The process then terminates.

According to this exemplary embodiment, it is possible to determine whether to permit execution of a document operation, such as storage, printing, copying, and movement of a document created using object data, by confirming a state of an area protected by the security attribute. Accordingly, since whether confidential information is effective in a document can be substantially determined instead of fixed determination based on existence or absence of object data, user friendliness of a system reusing object data can be improved.

### Fourth Exemplary Embodiment

A configuration of data processing programs that can be read by a document management system according to an exemplary embodiment of the present invention will be described below with reference to a memory map shown in FIG. 19.

FIG. 19 is a diagram illustrating a memory map of a storage medium that stores various data processing programs that can be read by the document management system according to the exemplary embodiment of the present invention.

Although not shown, the storage medium stores information for managing programs stored on the storage medium, such as, for example, version information and creator information. The storage medium may also store information depending on an operating system (OS) on a program reading side, such as, for example, icons to be displayed to identify the programs.

Data belonging to the various programs are managed in directories. In addition, the storage medium may store a program for installing the various programs in a computer and a program for decompressing a compressed program to be installed.

The functions shown in FIGS. 8, 11, 13, and 18 according to the exemplary embodiments may be realized by a host computer according to programs installed from the outside. In such a case, the present invention can be applied to a case where information including the programs is supplied to an output device from a storage medium, such as a CD-ROM, a flash memory, or a FD, or an external storage medium via a network.

As described above, a storage medium storing program codes of software for realizing the functions of the above-described exemplary embodiments is supplied to a system or an apparatus. A computer (or a CPU or an MPU) included in the system or the apparatus reads out and executes the program codes stored on the storage medium. The functions of the exemplary embodiments can be achieved in such a manner.

In this case, the program codes read out from the storage medium realizes novel functions of the present invention. The storage medium storing the program codes constitutes the present invention.

Accordingly, the program may be in any form, such as an object code, a program executed by an interpreter, or script data supplied to an OS, as long as the program has the functions of the program.

Types of a storage medium for use in supplying the program include, for example, a flexible disk, a hard disk, an optical disc such as a CD-ROM, a CD-R, a CD-RW, or a DVD, a magneto-optical disk such as an MO, a magnetic tape, a nonvolatile memory card, and a ROM.

In addition, the program supplying method includes a case where a user accesses an Internet web site using a browser of a client computer and downloads the computer program according to an exemplary embodiment of the present invention or a compressed file having an automatic installation function to a recording medium, such as a hard disk, from the web site. In addition, program codes constituting the program according to the exemplary embodiment of the present invention may be divided into a plurality of files and the plurality of files may be downloaded from different web sites. In this manner, the functions of the above-described exemplary embodiments can be realized. That is, the present invention also includes a WWW server or an ftp server that allows a plurality of users to download program files for realizing the functions of the exemplary embodiments of the present invention in a computer.

The program according to the exemplary embodiment of the present invention may be encrypted and recorded on a storage medium, such as a CD-ROM, and the storage medium may be distributed to users. In this case, users satisfying a predetermined condition may be permitted to download key information for decrypting the encryption from a web site via the Internet, execute the encrypted program using the key information, and install the program in a computer. In this manner, the functions of the above-described exemplary embodiments can be realized.

In addition to realization of the functions according to the above-described exemplary embodiments by the computer's execution of the read out program codes, an operating system (OS) running on the computer may execute part of or all of actual processing on the basis of instructions of the program codes, whereby the functions of the exemplary embodiments may be realized. The present invention also includes such a case.

Furthermore, the program read out from a storage medium may be written in a memory of a function expansion board inserted into the computer or a function expansion unit connected to the computer. A CPU or the like included in the function expansion board or the function expansion unit may execute part of or all of actual processing on the basis of instructions of the program codes, thereby realizing the functions of the above-described exemplary embodiments. The present invention also includes such a case.

It should be understood that the present invention is not limited to the above-described exemplary embodiments and can be variously modified based on the spirit of the present invention (including combinations of the exemplary embodiments). These modifications should not be excluded from the scope of the present invention.

Although the description has been given for various examples and exemplary embodiments of the present invention, the spirit and scope of the present invention should not be limited to the specific description given herein.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-124572 filed on May 12, 2008, which is hereby incorporated by reference herein in its entirety.

What is claimed is:

1. An information processing apparatus comprising:
a display control unit configured to display a document created using object data to which a security level is set as attribute information; and
a presenting unit configured to present, at the time of execution of processing on the document displayed by the display control unit, second object data different from first object data when a result of comparison of a security level corresponding to content of the processing to be executed on the document and a security level of the first object data included in the document displayed by the display control unit indicates that the security level of the first object data included in the document displayed by the display control unit is higher than the security level corresponding to the content of the processing to be executed on the document.

2. The apparatus according to claim 1, wherein the processing executed on the document is storage of the document displayed by the display control unit, and
wherein the security level corresponding to the content of the processing indicates a security level corresponding to a storage destination of the document.

3. The apparatus according to claim 1, wherein the processing executed on the document is printing of the document displayed by the display control unit, and
wherein the security level corresponding to the content of the processing indicates a security level corresponding to a print setting employed at the time of printing.

4. The apparatus according to claim 1, wherein the processing executed on the document is transmission of the document displayed by the display control unit as mail, and
wherein the security level corresponding to the content of the processing indicates a security level corresponding to address information.

5. The apparatus according to claim 1, further comprising:
a control unit configured to control the processing executed on the document when the result of comparison of the security level corresponding to the content of the processing and the security level of the first object data included in the document displayed by the display control unit indicates that the security level of the first object data included in the document displayed by the display control unit is higher than the security level corresponding to the content of the processing to be executed on the document,
wherein the control unit controls the processing executed on the document, including the second object data presented by the presenting unit instead of the first object data, displayed by the display control unit.

6. The apparatus according to claim 1, wherein the presenting unit presents, at the time of execution of the processing on the document displayed by the display control unit, third object data that permits the processing on the document including the first object data to be executed when the result of comparison of the security level corresponding to the content of the processing to be executed on the document and the security level of the first object data included in the document displayed by the display control unit indicates that the security level of the first object data included in the document displayed by the display control unit is higher than the security level corresponding to the content of the processing to be executed on the document, and
wherein the control unit controls the processing executed on the document, including the first object data and the third object data presented by the presenting unit, displayed by the display control unit.

7. An information processing apparatus comprising:
a display control unit configured to display a document created using object data to which a security level is set as attribute information; and
a presenting unit configured to present, at the time of execution of processing on the document displayed by the display control unit, second processing content different from first processing content when a result of comparison of a security level corresponding to the first processing content of the processing to be executed on the document and a security level of the object data included in the document displayed by the display control unit indicates that the security level of the object data included in the document displayed by the display control unit is higher than the security level corresponding to the first processing content of the processing to be executed on the document.

8. An information processing method comprising:
displaying a document created using object data to which a security level is set as attribute information; and
presenting, at the time of execution of processing on the displayed document, second object data different from first object data when a result of comparison of a security level corresponding to content of the processing to be executed on the document and a security level of the first object data included in the displayed document indicates that the security level of the first object data included in the displayed document is higher than the security level corresponding to the content of the processing to be executed on the document.

9. The method according to claim 8, wherein the processing executed on the document is storage of the displayed document, and
wherein the security level corresponding to the content of the processing indicates a security level corresponding to a storage destination of the document.

10. The method according to claim 8, wherein the processing executed on the document is printing of the displayed document, and
wherein the security level corresponding to the content of the processing indicates a security level corresponding to a print setting employed at the time of printing.

11. The method according to claim 8, wherein the processing executed on the document is transmission of the displayed document as mail, and
wherein the security level corresponding to the content of the processing indicates a security level corresponding to address information.

12. The method according to claim 8, further comprising:
controlling the processing executed on the document when the result of comparison of the security level corresponding to the content of the processing and the security level of the first object data included in the displayed document indicates that the security level of the first object data included in the displayed document is higher than the security level corresponding to the content of the processing to be executed on the document,
wherein controlling the processing executed on the displayed document includes the presented second object data instead of the first object data.

13. The method according to claim 8, wherein presenting includes, at the time of execution of the processing on the displayed document, third object data that permits the processing on the document including the first object data to be executed when the result of comparison of the security level corresponding to the content of the processing to be executed on the document and the security level of the first object data included in the displayed document indicates that the security level of the first object data included in the displayed document is higher than the security level corresponding to the content of the processing to be executed on the document, and
wherein controlling the processing executed on the displayed document includes the first object data and the presented third object data.

14. An information processing method comprising:
displaying a document created using object data to which a security level is set as attribute information; and
presenting, at the time of execution of processing on the displayed document, second processing content different from first processing content when a result of comparison of a security level corresponding to the first processing content of the processing to be executed on the document and a security level of the object data included in the displayed document indicates that the security level of the object data included in the displayed document is higher than the security level corresponding to the first processing content of the processing to be executed on the document.

15. A computer-readable storage medium storing a program for realizing an information processing method, the method comprising:
displaying a document created using object data to which a security level is set as attribute information; and
presenting, at the time of execution of processing on the displayed document, second object data different from first object data when a result of comparison of a security level corresponding to content of the processing to be executed on the document and a security level of the first object data included in the displayed document indicates that the security level of the first object data included in the displayed document is higher than the security level corresponding to the content of the processing to be executed on the document.

16. A computer-readable storage medium storing a program for realizing an information processing method, the method comprising:
displaying a document created using object data to which a security level is set as attribute information; and
presenting, at the time of execution of processing on the displayed document, second processing content different from first processing content when a result of comparison of a security level corresponding to the first processing content of the processing to be executed on the document and a security level of the object data included in the displayed document indicates that the security level of the object data included in the displayed document is higher than the security level corresponding to the first processing content of the processing to be executed on the document.
